(19) United States
(12) Patent Application Publication
(10) Pub. No.: US 2007/0212632 A1
(43) Pub. Date: Sep. 13, 2007

(54) Toner for developing electrostatic charge image and image forming method

(76) Inventors: Kouzou Teramoto, Osaka-shi (JP); Tomohiko Kubo, Kobe-shi (JP)

Correspondence Address: CLARK & BRODY, 1090 VERMONT AVENUE, NW, SUITE 250, WASHINGTON, DC, 20005, US

(21) Appl. No.: 11/711,092

(22) Filed: Feb. 27, 2007

(30) Foreign Application Priority Data
Feb. 28, 2006 (JP) 2006-054096

(51) Int. Cl. G03G 9/08; G03G 21/00

(52) U.S. Cl. 430/111.4; 430/119.82; 430/123.58

(57) ABSTRACT

Disclosed is a toner for developing an electrostatic charge image, which contains at least a binder resin, a release agent, and a charge control agent. The ratio of an average charge amount of toner developed on an electrostatic charge image carrier to an average charge amount of a toner thin layer on a developer carrier before development satisfies following equation (1), and the toner has a mean roundness of 0.935 to 0.985,
1.0≦A/B≦3.0 (1) where A is an average charge amount of toner after development; and B is an average charge amount of toner before development.

### BACKGROUND OF THE INVENTION

1. Field of the Invention

The present invention relates to a dry-type toner for developing an electrostatic charge image (an electrostatic latent image), which can be formed by electrophotography method, electrostatic recording method, electrostatic printing method, or the like. The invention also relates to an image forming method.

2. Description of Related Art

Generally, high quality images are attainable by electrophotography method or electrostatic recording method. Specifically, an electrostatic charge image carrier formed of a photoconductive material or dielectric is electrically charged by corona electrical charging, and an electrostatic image formed on the electrostatic charge image carrier by exposure using laser, an LED, or the like is visualized with a developer such as toner, alternatively, an electrostatic latent image is visualized by reversal development. As the toners usually applied to these developing methods, there have been used toner particles having a mean particle diameter of 5 to 15 μm, which can be manufactured in the follow manner. That is, a coloring agent, a dye and a pigment as a charge control agent, and wax as a release agent are mixed with a thermoplastic rein as binder, followed by kneading, grinding, and classification. Alternatively, toner particles manufactured by chemical polymerization can be used. In general, flowability is imparted on the above-mentioned toner particles, the charge control of the toner particles is performed, and an inorganic fine powder or an inorganic metal fine powder, such as silica, titaniumoxide or the like, is added to improve cleaning property.

As a dry-type development method in various electrostatic copying systems for practical use, there have been known a two-component development system using toner and carrier such as ion powder, andmagnetic one-component development systemwhere no carrier is used and a magnetic body is contained in the inside of the toner.

At present, many methods of developing an electrostatic latent image are developed and put into practice. There are known, for example, the magnetic brush method described in the specification of U.S. Pat. No. 2,874,063, the cascade development method described in the specification of U.S. Pat. No. 2,618,552, and many development methods such as powder crowd method and fur brush development method. Among others, the magnetic brush method and the cascade method, each using a two-component developer composed mainly of toner and carrier, are widely used. These methods using the two-component developer can provide good quality images relatively stably at the initial stage. However, these methods have the following common disadvantages. That is, if used for a long term, carrier deterioration, namely spent phenomenon arises, and the charge supplying capability of the carrier is lowered, thus failing to provide good quality images for a long term. There is also a lack of long-term durability because it is hard to hold constant the mixing ratio of the toner and the carrier.

Therefore, various proposals have been made in order to realize high resolution and high image quality for a long term by ensuring the formation of a stable toner thin layer that determines whether the image quality of an electrostatic latent image development system is superior or not.

For example, in Japanese Unexamined Patent Publication No. 2001-147588, by a contact charging system, the charge amount of a toner layer is defined by adjusting the line speeds of a developer supplying member and a developing sleeve, and devising the way of putting the toner on the developing sleeve. However, this increases the occasions where the toner contacts with the developer supplying member and the developing sleeve, and the toner deteriorates considerably. It is therefore impossible to perform the image formation that can accommodate high speed and high image quality, failing to achieve high durability. In Japanese Unexamined Patent Publication No. H11-52627, it is also proposed to adjust the charge amount of the toner by setting, when blending a charge control agent into the toner, a predetermined blending ratio so as to cause mutual grinding at a nip part during the time the above-mentioned developer carrying means performs development. However, the charge amount of the toner also depends on the particle size and the roundness of the toner. It is therefore difficult to adjust the charge amount of the toner only by the material of the toner.

On the other hand, in Japanese Unexamined Patent Publication No. 2001-147590, it is proposed to adjust the charge amount of the toner by further using a corona charger to stabilize the charge of the electrically charged toner obtained by frictional charging, and eliminating the toner having the reverse polarity from a toner layer formed on a developer carrier by devising a bias applied. In Japanese Unexamined Patent Publication No. 2001-34067, it is proposed to adjust the charge amount of the toner by defining the electrostatic capacity of a photosensitive drum and the half breadth of the principal pole of a magnet within a developer carrier. However, when the adjustment of the charge amount of the toner is dependent on the apparatus side, the system will be complicated. This tendency can increase the possibility of a rise in costs and malfunction.

On the other hand, Japanese Unexamined Patent Publication No. H11-288125 has proposed to improve development property and transfer property by giving attentions to the roundness of the toner. That is, the roundness is controlled to 0.970 to 0.995, and the toner having a roundness of 0.950 or below is controlled to 15% by number, and the melting temperature of a wax component in styrene monomer is set to 35° C. to 80° C. In general, the settling of an external additive into toner is advanced as the shape of the toner approaches spherical. It is therefore difficult to retain high durability.

In the market of copying machines and printers employing electrophotography method or electrostatic printing method, high speed printing, small machine, as well as long machine life, and high durability are remarkably advanced in the recent years. Toner having stable charging property is essential to achieve improvements of image characteristics and durability that can accommodate the tendency of high printing speed. In middle or low speed machines used in offices and homes where compact machines are desirable, the warming-up time after turning on the power is short and hence toner having superior initial charging is required. There is also a similar tendency in high-speed machines. This trend is important from a viewpoint of energy saving. That is, there is a desire for toners capable of stably retaining charging property for a long period of time.

### SUMMARY OF THE INVENTION

A primary advantage of the present invention is to provide toners for developing an electrostatic charge image, as well as an image forming method. The toners are of high image quality and high durability and capable of coping with environmental variations even in a high speed system, by forming a stable toner thin layer so as to stably retaining toner charging characteristics.

The present inventors have made tremendous research effort to solve the above-mentioned problems, and have discovered that toners and image forming methods which are excellent in image quality and durability can be provided by setting the mean roundness of the toner, and the ratio of the charge amounts of the toner before and after development (hereinafter referred to simply as the “ratio of charge amount” in some cases).

Specifically, a toner for developing an electrostatic charge image according to the present invention contains at least a binder resin, a release agent, and a charge control agent. The ratio of an average charge amount of the toner developed on an electrostatic charge image carrier and an average charge amount of a toner thin layer on a developer carrier before development satisfies the following equation (1):
1.0≦A/B≦3.0 (1)
where A is an average charge amount of toner after development; and B is an average charge amount of toner before development. The toner has a mean roundness of 0.935 to 0.985.

An image forming method according to the present invention uses a contact transfer system in a transfer step and a blade cleaning system in a cleaning step, and uses the toner as described above.

Specifically, the image forming method of the present invention includes: a contact charge step of applying a charge voltage by bringing a charge roller into contact with a surface of an electrostatic charge image carrier; an exposure step of forming an electrostatic latent image by exposing the surface of the electrostatic charge image carrier; a development step of forming a toner image by allowing a charged toner of a predetermined polarity to adhere from a developer carrier to the electrostatic latent image on the electrostatic charge image carrier; a contact transfer step of transferring the toner image on the electrostatic charge image carrier to a transfer material conveyed by applying a transfer voltage to the transfer material; and a cleaning step of recovering by a cleaning blade a non-transferred toner remained on the electrostatic charge image carrier. It is especially preferred to apply the above-mentioned toner to this image forming method.

In accordance with the toner for developing an electrostatic charge image and the image forming method, a stable toner thin layer can be formed and hence toner charging characteristics can be retained stably for a long period of time, by setting the ratio of the average charge amount of the toner developed on the electrostatic change image carrier and the average charge amount of the toner thin layer on the developer carrier, to the predetermined range. This enables handling of high image quality, high durability, and environmental variations.

In particular, the toner of the present invention having a specific mean roundness can eliminate poor cleaning due to slipping through the cleaning blade, and reduce toner omissions in printed characters (i.e. “nakanuke” phenomenon in Japanese) in the toner image transfer in the contact transfer step.

Other objects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating an image forming apparatus according to a preferred embodiment of the present invention; and

FIG. 2A is a scanning electron microscope (SEM) photograph showing toner particles of Sample No. 2 in Example 1, which is within the scope of the present invention; and FIG. 2B is a scanning electron microscope (SEM) photograph showing toner particles of Sample No. 7, which is beyond the scope of the present invention.

### DETAILED DESCRIPTION OF PREFERRED EMBODIMENTS

A toner for developing an electrostatic image and an image forming method according to the present invention will be described below in detail. The toner for developing an electrostatic image has the features that the particles of the toner have a mean roundness of not less than 0.935 nor more than 0.985; and that the ratio of the average charge amount of the toner developed on an electrostatic charge image carrier and the average charge amount of a toner thin layer on a developer carrier (a developing sleeve) before development satisfies the equation (1) as described above.

<Toner>

The toner particles of the present invention have a mean roundness of 0.935 to 0.985, as described above. In general, as the mean roundness of the toner is increased and approaches spherical shape, its flowability and transfer efficiency are superior, and it is therefore easy to maintain image density. However, when the mean roundness is too high, slipping through the cleaning blade is apt to occur, resulting in poor cleaning. When the mean roundness is lowered, toner omissions occur in the transfer in the transfer step (Namely, the phenomenon that non-printed portions appear in the printed characters). The toner particles of the present invention having the mean roundness within the above-mentioned range are in the shape of the increased roundness because the edges of the toner particles are rounded off. As the result, the distribution of charge amount can be sharpened by frictional electrification or the like, thus leading to the toner particles of uniform charge amount.

Here, the mean roundness can be found as follows. That is, measurements are made using a flow particle image analyzer, and the roundness of each of the measured particles is calculated by the following equation (2). The sum of the roundness values of all the measured particles is then divided by the total number of the particles.
Roundness=L₀/L (2)
where L₀ is the circumferential length of a circle having the same projection area as a particle image; and L is the circumferential length of the particle image.

The toner of the present invention is also the toner that the ratio of the average charge amount of the toner developed on an electrostatic charge image carrier and the average charge amount of a toner thin layer on a developer carrier before development satisfies the above-mentioned equation (1). As described above, the toner particles, whose roundness is increased by rounding off the edges of the toner particles, have a sharp distribution in the charge amount, enabling the control of a suitable charge amount for development. By setting the ratio of charge amount within the range of the present invention by using these toner particles, the charge amount of the toner on the developing sleeve and that of the toner on the electrostatic charge image carrier have a sharp distribution. This enables the appropriate development to the electrostatic charge image carrier, thereby providing high image quality. Further in the present invention, the adjustment of the charge amount of the toner particles does not depend on any external additive, and it depends on the characteristics of the toner particles. Consequently, even if used for a long time, the external additive cannot settle in the toner particles, thereby ensuring high durability.

In contrast, when the ratio of charge amount exceeds 3.0, the distribution of the charge amount of the toner on the developing sleeve expands, and the entire toner might not contribute to the development. That is, the case where the ratio of charge amount exceeds 3.0 means that the average charge amount of the toner after the development is high. Since the toner is required to have a suitable charge amount for development, the fact that a high average charge amount of the toner after the development means that the toner left on the developer carrier (the developing sleeve) contains ones whose average charge amount is low and hence unsuitable for development (Specifically, the presence of the reverse charge toner can be assumed). Therefore, this creates the condition where only the toners of high charge amount in the toners existing on the developing sleeve are apt to be developed in a suitable range for development, and the number of toners developed can be reduced. As the result, the image density is lowered, and the reproducibility of fine lines and 1-dot is deteriorated. Further, the reverse charge toner is apt to fly to a non-latent image part, and there is a fear that fog would occur.

On the other hand, the case where the ratio of charge amount is less than 1.0 means that the average charge amount of the toner after the development is smaller than the average charge amount of the toner before the development, and a large number of toners of high charge amount which do not contribute to the development (so-called charge-up toners) are present on the developing sleeve. In this case, as the development is advanced, the ratio of the charge-up toners is further increased on the developing sleeve. This causes the problem in term of durability, such as a remarked drop in image density.

Thus, when the ratio of charge amount is not within the above-mentioned range in the present invention, there may arise such a selection phenomenon that only the toners having a specific charge amount are easily developed, and it is difficult to ensure high image quality and high durability.

The toner used in the present invention can be manufactured in the following manner. That is, a release agent, coloring agent and, a charge control agent are added to a predetermined amount of a binder resin, followed by stirring and mixing with a mixer such as a Henshel mixer. The mixture thus obtained is melt-kneaded with a biaxial extruder or the like, and then cooled, followed by grinding with a grinder such as a hammer mill or a jet mill. Subsequently, this is classified with a classifier such as a pneumatic classifier, resulting in the toner particles having a predetermined particle size. Next, a predetermined amount of the above-mentioned external additive is added to the obtained toner particles, and this is then stirred and mixed with a mixer such as a Henshel mixer.

The roundness of the toner particles can be found with high accuracy by subjecting the toner particles to a flow grinder and then to a mechanical grinder. It is also possible to add a process in the grinding step, such as a plurality of passages through the mechanical grinder, and the shape control and the surface control of the toner by an impact powder processing apparatus using a rotary blade. The impact powder processing apparatus using the rotary blade can employ a known system such as a hybridization system or an impact fine grinder. A method of using a processing apparatus equipped with a rotary blade is suitable in order to control the shapes of the toner particles accurately and entirely uniformly. It is more suitable to use a processing apparatus equipped with a rotary blade that rotates at high speed, while vigorously dispersing the powder.

It is, of course, possible to use a heat processing apparatus (a suffusion system or the like) or a jet type sphere manufacturing apparatus. For a two-component developer, it is possible to employ a polymerization method such as suspension polymerization, solution polymerization, dispersion polymerization, emulsification polymerization, or soap free method, each of which is capable of directly manufacturing the toner.

The ratio of charge amount of the toner can be adjusted by, for example, adding an external additive. Preferably, besides the addition of an external additive, or without adding any external additive, the adjustment is made by properly sharpening the roundness distribution of the toner particles, namely minimizing the edges of the toner particles. That is, by eliminating the edges of the toner particles to increase the roundness, the distribution of the charge amount of the toner can be sharpened by frictional electrification. This enables the control of the ratio of charge amount of the toner before and after the development.

A similar effect is attainable by sharpening the particle size distribution of the toner particles. It is known that toners are usually subject to considerable physical stress such as stirring in a container, stirring and conveyance in a developer, and frictional electrification on a sleeve. Therefore, by performing the particle size control of the toner particles, instead of or together with the control of the roundness distribution, the toner particles can retain the ratio of charge amount for a long period of time, without depending on the external additive that often causes separation from the toner particles and settling in the toner particles. This realizes high durability.

The mean particle size of the toner particles may be 5.0˜10.0 μm, preferably 6.5˜8.5 μm, more preferably 7.0˜8.5 μm. The mean particle diameter of the toner particles can be measured by using a Coulter counter “Multisizer 3” manufactured by Beckman Coulter, Inc. Isoton II (manufactured by Beckman Coulter, Inc.) was used as an electrolyte solution, and 100-micrometer aperture is used as aperture. Specifically, 10 mg of measurement sample was added into the solution prepared by adding the little surface active agent into the above-mentioned electrolyte, and distributed processing is performed by using an ultrasonic dispersion machine. The solution in which the measurement sample is dispersed is measured with the above-mentioned measurement equipment, and the volume mean particle diameter was obtained.

<External Additive>

It is preferable to use, as an external additive, fine particles (usually, 1.0 μm or less in mean particle diameter) such as of colloidal silica, hydrophobic silica, alumina, or titanium oxide, in order to impart flowability and cleaning property to the toner. A developer obtained by externally adding these can be used for developing an electrostatic latent image formed on the surface of an electrostatic charge image carrier.

Each of the above fine-grain external additives is used to improve flowability, preservation stability, and cleaning property by the surface treatment of the toner, and usually used in 0.2 to 10.0 mass parts per 100 mass parts of the toner. The fine particles of these can be externally added by dry-type stirring and mixing together with a magnetic toner. In this case, it is desirable to use a Henshel mixer or Nauter mixer, in order to avoid the fine particles from settling in the toner.

<Binder Resin>

No particular limitations are imposed on binder resin. It is however preferable to use, for example, thermoplastic resin such as styrene resin, acryl resin, styrene-acryl copolymer, polyethylene resin, polypropylene resin, vinyl chloride resin, polyester resin, polyamide resin, polyurethane resin, polyvinyl alcohol resin, vinyl ether resin, N-vinyl resin, or styrene-butadiene resin.

More specifically, polystyrene resin may be homopolymer of styrene or copolymer with other copolymer monomer that can be copolymerized with styrene. Examples of copolymer monomer are ethylene unsaturated monoolefins such as p-chlorstyrene, vinylnaphthalene, ethylene, propylene, butylene, and isobutylene; vinyl halide such as vinyl chloride, vinyl bromide, and vinyl fluoride; vinyl esters such as vinyl acetate, vinyl propionic acid, vinyl benzoe acid, and vinyl butyric acid; meta-acrylic esters such as methyl acrylate, ethyl acrylate, n-butyl acrylate, isobutyl acrylate, dedecyl acrylate, n-octyl acrylate, 2-chloromethyl acrylate, phenyl acrylate, α-chloromethyl acrylate, metyl methacrylate, ethyl methacrylate, and butyl methacrylate; other acrylate derivatives such as acrylonitrile, meta-acrylonitrile, and acryl amide; vinyl ethers such as vinylmethyl ether, and vinyl isobutyl ether; vinyl ketones such as vinyl methyl ketone, vinyl ethyl ketone, and methyl isopropenyl ketone; and N-vinyl compounds such as N-vinyl pyrrole, N-vinyl carbazole, N-vinyl indole, and N-vinyl pyrrolidine. These can be used solely. Alternatively, or two or more types of these may be combined so as to be copolymerized with styrene monomer.

Specifically, it is possible to use any one of polyester resins obtainable through condensation polymerization or co-condensation polymerization of an alcohol component and a carboxylic acid component. Examples of components used in synthesizing polyester resin are as follows. As an alcohol component of bivalent, trivalent or polyvalent, there are diols such as ethylene glycol, diethylene glycol, triethylene glycol, 1,2-propylen glycol, 1,3-propylene glycol, 1,4-butanediol, neopentyl glycol, 1,4-butenediol, 1,5-pentanediol, 1,6-hexanediol, 1-4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trivalent or polyvalent alcohols such as sorbitol, 1,2,3,6-hexanetetrol, 1,4-sorbitane, pentaerythritol, dipentaerythritol, tripentaerythritol, 1,2,4-butanetriol, 1,2,5-pentanetriol, glycerol, diglycerol, 2-methylpropanetriol; 2-methyl-1,2,4-butanetriol, trimethylolethane, trimethylolpropane, and 1,3,5-trihydroxymethylbenzene.

As a carboxylic acid component of bivalent, trivalent or polyvalent, bivalent or trivalent carboxylic acid, acid anhydride thereof, or lower alkyl ester thereof can be used. There are, for example, bivalent carboxylic acids of alkyl or alkenylsuccinic acid, such as maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, or n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecylsuccinic acid, n-dodecenylsuccinic acid, isododecylsuccinic acid, isododecenylsuccinic acid; and trivalent or polyvalent carboxylic acids such as 1,2,4-benzenetricarboxylic acid (trimellitic acid), 1,2,5-benzenecarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylcarboxyl)methane, 1,2,7,8-octanetetracarboxylic acid, pyromellitic acid, and enpole trimer acid. The softening point of polyester resin is preferably 110 to 150° C., more preferably 120 to 140° C.

The binder resin may be thermoplastic resin. Such an introduction of a partial cross linking structure enables to further improve the toner storage stability, shape holding property, and durability, without lowering fixing property. This eliminates the need to use 100 mass parts of thermoplastic resin as the binder resin of the toner. It is also preferable to add a cross linking agent or use thermoplastic resin partially.

As the thermoplastic resin, epoxy resin, cyanate resin, etc. can be used. More specifically, bisphenol A type epoxy resin, hydrogenated bisphenol A type epoxy resin, novolak type epoxy resin, polyalkyl ether type epoxy resin, circular aliphatic epoxy resin, and cyanate resin can be used solely or in combination of two or more types.

In the present invention, the glass transition point (Tg) of a binder resin is preferably 50 to 65° C., more preferably 50 to 60° C. When the glass transition point is lower than the above range, the obtained toners may become fused each other in a developing apparatus, which can deteriorate storage stability. Additionally, because resin strength is low, there is a tendency to cause the adhesion of the toner to the photosensitive material. When the glass transition point is higher than the above range, the low-temperature fixing property of the toner may be lowered. The glass transition point of the binder resin can be found from a change point of specific heat by using a differential scanning calorimeter (DSC). Specifically, it can be determined by measuring an endothermic curve by using a differential scanning calorimeter “DSC-6200,” manufactured by Seiko Instruments Co., Ltd., as measurement equipment. A 10 mg of test portion is put in an aluminum pan, and an empty aluminum pan is used as reference. In ordinary temperature and ordinary humidity, a measurement is made at a measuring temperature range of 25 to 200° C., and a temperature raising speed of 10° C./min, thereby obtaining an endothermic curve, from which a glass transition point is found.

<Magnetic Powder>

When the developer is a magnetic toner, a magnetic powder is contained in the toner. Examples of the magnetic powder are ones known by themselves, for example, metals exhibiting ferromagnetism such as ferrite, iron, e.g., magnetite, cobalt, and nickel; alloys or compounds containing these elements; alloys that contain no ferromagnetic element but can exhibit ferromagnetism by applying a suitable heat treatment thereto; and chromium dioxide.

Each of these magnetic powders is dispersed uniformly in the above-mentioned binder resin, in the form of fine powder having a mean particle size of 0.1 to 1 μm, especially 0.1 to 0.5 μm. The magnetic powder can also be used after being subjected to surface treatment with a surface treatment agent such as titanium coupling agent or silane coupling agent.

The magnetic powder is preferably contained in the toner in an amount of 30 to 60 mass parts, preferably 45 to 55 mass parts. The use of magnetic powder exceeding this range may deteriorate the durability of image density, and have a tendency that fixing property is extremely lowered. On the other hand, the use of less than this range may cause poor image density durability due to fog.

Although no particular limitations are imposed on the shape of the magnetic powder used in the present invention, it can be expected that, when the contained magnetic powder is in the shape of a polyhedron having edges (such as octahedron, hexahedron, or the like), instead of spherical shape, one or more corners of the magnetic powder are exposed from the toner surface. By setting the content of the magnetic powder to the range of 40 to 55 mass parts, it is possible to obtain more effectively the effect of discharging gradually the charge of the remaining toner from the edges of the magnetic powder, before the potential of the toner remaining at the blade edge reaches the breakdown potential of the photosensitive material by the frictional electrification with the blade.

In the observation of the shape of the magnetic powder, as required, samples can be observed at any magnification on a transmission electron microscope (TEM) H-700H, H-800, or H-7500 (each manufactured by Hitachi, Ltd.), or a scanning electron microscope (SEM) S-800 or S-4700 (each manufactured by Hitachi, Ltd.), at a magnification of ×20000 to ×200000, and at a photo finishing magnification of ×1 to ×10.

<Pigment>

As a pigment, a dye such as carbon black or acid violet can be dispersed as a coloring agent in a binder resin. This coloring agent is usually blended in an amount of 1 to 10 mass parts to 100 mass parts of the above binder resin. This is for the purpose of adjusting color tone, as in the case with known ones. Alternatively, the color pigments of the respective colors for color toners can be used.

No particular limitations are imposed on the coloring agent as pigment. Examples of black coloring agent are carbon black such as acetylene black, run black, and aniline black. Examples of magenta coloring agent are C. I. pigment red 81, C. I. pigment red 122, C. I. pigment red 57, C. I. pigment red 238, C. I. pigment red 49, C. I. solvent red 49, C. I. solvent red 19, C. I. solvent red 52, C. I. basic red 10, and C. I. disperse red 15, all of which are listed on Color Index. Examples of cyan coloring agent are C. I. pigment blue 15, C.I. pigment 15-1, C. I. pigment 15-3, C. I. pigment blue 16, C. I. solvent blue 55, C.I. solvent blue 70, C. I. direct blue 86, and C. I. direct blue 25, which are presented in Color Index. Examples of yellow coloring agent are nitro pigments such as naphthol yellow S, azo pigments such as Hansa yellow 5G, Hansa yellow 3G, Hansa yellow G, benzidine yellow G, and vulcan fast yellow 5G; inorganic pigments such as yellow iron oxide, and loess; C. I. pigment yellow 180, C. I. pigment yellow 74, C. I. solvent yellow 2, C. I. solvent yellow 6, C. I. solvent yellow 14, C. I. solvent yellow 15, C. I. solvent yellow 16, C. I. solvent yellow 19, and C. I. solvent yellow 21, all of which are listed on Color Index. These coloring agents may be used solely or in combination.

<Charge Control Agent>

A charge control agent is blended in order to significantly improve charge level and charge rise property (an index indicating whether it is possible to charge to a certain charge level in a short time), and attain the characteristics excellent in durability and stability. Specifically, a charge control agent of positive charging property can be added when the toner is positively charged for development, and a charge control agent of negative charging property can be added when the toner is negatively charged for development.

No special limitation is imposed on such a charge control agent. As example of the charge control agent of positive charging property, there are azine compounds such as pyridazine, pyrimidine, pyrazine, orthooxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of an azine compound, such as azine first red FC, azine first red 12BK, azine violet BO, azine brown 3G, azine light brown GR, azine dark green BH/C, azine deep black EW, and azine deep black 3RL; nigrosine compounds such as nigrosine, nigrosine salt, and nigrosine derivative; acid dyes composed of a nigrosine compound, such as nigrosine BK, nigrosine NB, and nigrosine Z; metallic salts of naphthenic acid or higher fatty acid; alkoxylate amine; alkylamide; and quaternary ammonium salts such as benzylmethylhexyldecyl ammonium, and decyltrimethyl ammonium chloride. These may be used solely. Alternatively, two or more of these may be used together. In particular, nigrosine compound is the most suitable for use as a positive charging property toner, because a speedier rise property is achievable.

It is also possible to use, as a charge control agent of positive charging property, quaternary ammonium salt, carboxylate, and resin or oligomer having a carboxyl group as a functional group. Specifically, there are styrene resin having quaternary ammonium salt, acrylic resin having quaternary ammonium salt, styrene-acrylic resin having quaternary ammonium salt, polyester resin having quaternary ammonium salt, styrene resin having carboxylate, acrylic resin having carboxylate, styrene-acrylic resin having carboxylate, polyester resin having carboxylate, polystyrene resin having carboxyl group, acrylic resin having carboxyl group, styrene-acrylic resin having carboxyl group, and polyester resin having carboxyl group. These may be used solely. Alternatively, two or more kinds of these may be used together.

In particular, styrene-acrylic copolymerized resin having quaternary ammonium salt as a functional group is the most suitable because it is easy to adjust the charge amount to a value in the desired range. In this case, examples of preferable acrylic comonomer to be copolymerized with the above-mentioned styrene unit are (meta)alkyl ester acrylate such as methyl acrylate, ethyl acrylate, n-propyl acrylate, iso-propyl acrylate, n-butyl acrylate, iso-butyl acrylate, 2-ethylhexyl acrylate, methyl metaacrylate, ethyl metaacrylate, n-butyl metaacrylate, and iso-butyl metaacrylate. As quaternary ammonium salt, there can be used such a unit that is induced through the step of bringing dialkylaminoalkyl(meta)acrylate into quaternary one. Examples of suitable dialkylaminoalkyl(meta)acrylate are di(lower alkyl)aminoethyl(meta)acrylate such as dimethylaminoethyl(meta)acrylate, diethylaminoethyl(meta)acrylate, dipropylaminoethyl(meta)acrylate, and dibutylaminoethyl(meta)acrylate; dimethylmetacrylamide, and dimethylaminopropylmetacrylamide. Further, polymerized monomer containing hydroxy group, such as hydroxyethyl(meta)acrylate, hydroxypropyl(meta)acrylate, 2-hydroxybuthyl(meta)acrylate, or N-methylol(meta)acrylamide, can be used together at the time of polymerization.

As a charge control agent of negative charging property, organic metallic complex, chelated compound, etc. are effective. For example, there are aluminumacetyl acetonate, iron (II) acetyl acetonate, and 3,5-di-tert-butyl salicylate chrome. In particular, acetylacetone metallic complex, and salicylic acid metallic complex or salt are preferable. Among others, salicylic acid metal complex or salicylic acid metallic salt is especially preferable.

The above-mentioned charge control agent of positive or negative charging property is contained in the toner in an amount of 1.5 to 15 mass parts, preferably 2.0 to 8.0 mass parts, more preferably 3.0 to 7.0 mass parts (Provided that the entire amount of the toner is 100 mass parts.). When the charge control agent content is less than the above range, there is a tendency to have difficulties in stably charging the toner to a predetermined polarity. If this toner is used to develop an electrostaticlatent image so as to form an image, there is a tendency to decrease image density and deteriorate the durability of the image density. Further, the charge control agent is susceptible to poor dispersion. This can cause so-called fog, and create a tendency to strengthen the contamination of photosensitive material. On the other hand, when the charge control agent content exceeds the above range, there is a tendency to have drawbacks in environment resistance, such as poor charge and poor image especially in high-temperature and high-humidity, so that the contamination of photosensitive material is apt to occur.

<Release Agent>

As a release agent, waxes can be used. No special limitation is imposed thereon. It is however preferable to use, for example, polyethylene wax, polypropylene wax, Teflon wax, Fischer-Tropsch wax, paraffin wax, ester wax, montan wax, and rice wax. Two or more kinds of these may be used together. The addition of the above wax enables more efficient prevention of offset property and image smearing.

No special limitation is imposed on the amount of addition of the above waxes. It is however preferable to usually add 1 to 5 mass parts (Provided that the total amount of the toner is 100 mass parts.). When the wax content is less than 1 mass part, there is such a tendency that the offset property and image smearing cannot be prevented efficiently. On the other hand, when it exceeds 5 mass parts, there is such a tendency that the toners become fused each other, and storage stability is lowered.

<Image Forming Apparatus>

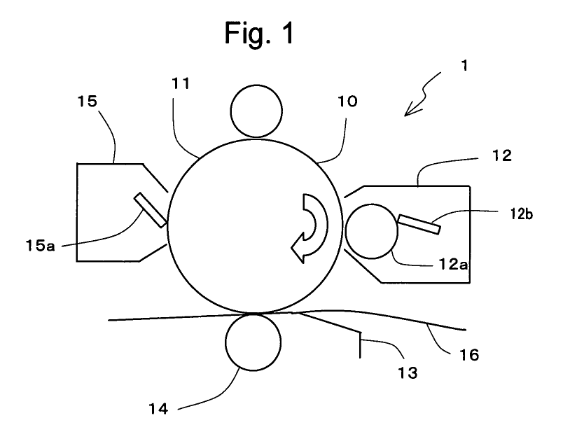

An image forming apparatus according to a preferred embodiment of the present invention will be described with reference to the accompanying drawings. FIG. 1 illustrates the schematic construction of an image forming apparatus 1 according to the preferred embodiment. The image forming apparatus 1 is provided with (i) an electrostatic charge image carrier drum 10 including an amorphous silicon drum, (ii) a charge roller 11 as a contact charging member that applies a charge voltage by making a contact with the surface of the electrostatic charge image carrier 10, (iii) exposure means (not shown) that forms an electrostatic latent image by exposing the surface of the electrostatic charge image carrier 10, (iv) developing means 12 such as a developing sleeve 12a that forms a toner image by allowing a charging toner of a predetermined polarity to adhere to an electrostatic latent image on the electrostatic charge image carrier 10, (v) a transfer member 14 such as a contact transfer roller that applies a transfer voltage to a transfer material 16 such as paper fed and conveyed by feeding and conveying means 13, thereby transferring the toner image on the electrostatic charge image carrier 10 to the transfer material 16; and (vi) an electrostatic charge image carrier cleaning means 15 (such as a cleaning bade 15a) that recovers non-transferred toner left on the electrostatic charge image carrier 10.

In synchronization with the formation of the toner image, the transfer material 16 such as paper is separately fed one by one from a cassette containing the transfer material 16, and the toner image formed on the drum 10 is transferred to a transfer material 8 by applying a voltage to the transfer member 14. The transfer material 8 is then conveyed to a fixing roller. The fixing roller fixes the transferred toner image by applying heat and pressure to the passing transfer material 16.

During the time of image formation, the electrostatic charge image carrier drum 10 is uniformly charged by the contact charging member 11, and an image exposure light such as LED or laser beam is irradiated from the exposure apparatus to the surface of the electrostatic charge image carrier drum 10, thereby forming an electrostatic latent image. That is, the potential of a light irradiating part is lowered to form the electrostatic latent image.

The developing means 12 is provided with a rotatable developing sleeve 12a (a developer carrier) disposed oppositely to the electrostatic charge image carrier drum 10. The developing means 12 develops (visualizes) a toner image by allowing a developer (toner) carried on the surface of the developing sleeve 12a to adhere to the electrostatic latent image on the surface of the electrostatic charge image carrier drum 10. That is, the developer within the developing means 12 is stirred by a stirring member, and subjected to frictional electrification so as to be the same polarity as the charging polarity of the electrostatic charge image carrier drum 10, and then conveyed toward the developing sleeve 12a. The developing sleeve 12a is arranged with a predetermined gap to the electrostatic charge image carrier drum 10, and the developer on the surface of the developing sleeve 12a can be formed in a predetermined layer thickness under the layer thickness regulation of a regulating blade. By applying a developing bias to the developing sleeve 12a, the charging toner is adhered to a location where the potential is lowered by the above-mentioned image exposure, so that a toner image can be formed on the surface of the electrostatic charge image carrier drum 10.

Subsequently, the contact transfer roller 14 applies a transfer voltage to the fed and conveyed transfer material 16, so that the toner image on the electrostatic charge image carrier drum 10 can be transferred to the transfer material 16. The remaining toner on the drum 10 is then removed and recovered by the cleaning blade 15a. The transfer material 8, to which the toner image has been transferred, is then conveyed to the fixing roller, which fixes the transferred toner image by applying heat and pressure to the transfer material 8.

As the material used in the developing sleeve 12a, for example, aluminium can be used. In consideration of high durability, it is preferable to use, as a sleeve material, stainless steel (SUS), such as SUS303, SUS304, SUS305, or SUS316. Among others, SUS305 is preferred which has weak magnetism and can be machined easily. In a low-speed electrophotography process, durability can be maintained even with a relatively soft material such as aluminium. However, durability cannot be ensured in a high-speed electrophotography process. Therefore, in order to cope with the high-speed process, stainless steel, which is hard to be damaged and cut, can be used to ensure high durability.

In the present invention, the developing sleeve using the stainless steel has a surface roughness Rz of 5.5 to 8.5 μm. When the surface roughness exceeds 8.5 μm, the thickness of the toner thin layer becomes too large, failing to obtain a stable layer. When the surface roughness is less than 5.5 μm, the toner conveying force is small and the thickness of the toner thin layer is small, so that the image density might be lowered. The above-mentioned surface roughness can be measured by using, for example, a surface roughness measuring instrument, “Surfcorder SE-30D”, manufactured by Kosaka Laboratory Ltd., according to JIS B 0601-2001.

The present invention will next be described in further detail by referring to examples and comparative examples. Although in the following examples, the invention is applied to a magnetic one-component developer (a magnetic toner), it is also applicable to a two-component developer formed of toner and carrier.

### EXAMPLES

### Example 1

### Manufacturing of Toner

To 49 mass parts of binder resin of styrene acrylic copolymer (47,000 in molecular weight (Mw) (peak 5,000; 931,000), 29.0 in molecular weight distribution (Mw/Mn), 5% in insoluble matter of tetrahydrofuran (THF), 55 in glass transition temperature (Tg)), 45 mass parts of magnetic powder (796 kA/m, 5.0 kA/m in holding power when printing, 82 Am²/kg in saturation magnetization, 11 Am²/kg in residual magnetization, and 0.22 μm in number average particle size), 3 mass parts of wax as a release agent (“Sasol Wax H1,” manufactured by Sasol Wax Kabushiki Kaisha), and 3 mass parts of quaternary ammonium salt (“Bontrol P-51,” manufactured by Orient Chemical Kabushiki Kaisha) as a positive charge control agent were added and mixed by a Henshel mixer. The mixture was melt-kneaded by a biaxial extruder, and cooled and then roughly ground by a hammer mill. This was further finely ground by a flow or mechanical grinder, and then classified by a flow classifier, thereby obtaining toner having a particle size distribution of a desired mean particle size.

Roundness was adjusted by subjecting the toner to the flow grinder and then to the mechanical grinder. That is, toner particles having a desired mean roundness were obtained through the process in a grinding step of having the toner pass through the mechanical grinder a plurality of times, under the shape control and surface control of the toner by an impact powder processing apparatus using a rotary blade (for example, a hybridization system manufactured by Nara Kikai Kabushiki Kaisha).

The ratio of charge amount was adjusted by adjusting the particle size distribution and mean roundness of the toner particles. The charge amount of the toner tends to increase as the roundness is increased. Similarly, the charge amount of the toner on the surface of the developing sleeve tends to increase since it is easy to increase charge as the mean particle size is decreased. Hence, the mean particle size and the mean roundness were adjusted to the combinations as shown in Table 1 described later, and the ratio of charge amount was adjusted. Toner particles having a broader toner particle size distribution were prepared by adjusting the classification point in the classification (Samples Nos. 10 and 11).

To the toner powder obtained above, 2.0 mass parts of titanium oxide (“ST-100”, manufactured by Titan Kogyo Kabushiki Kaisha), and 1.0 mass part of silica (“RA-200H”, manufactured by NIPPON AEROSIL CO., LTD.) were added and stirred within the Henshel mixer for two minutes, so that titanium oxide and silica were adhered on the surface of this powder, resulting in the toner for developing an electrostatic charge image.

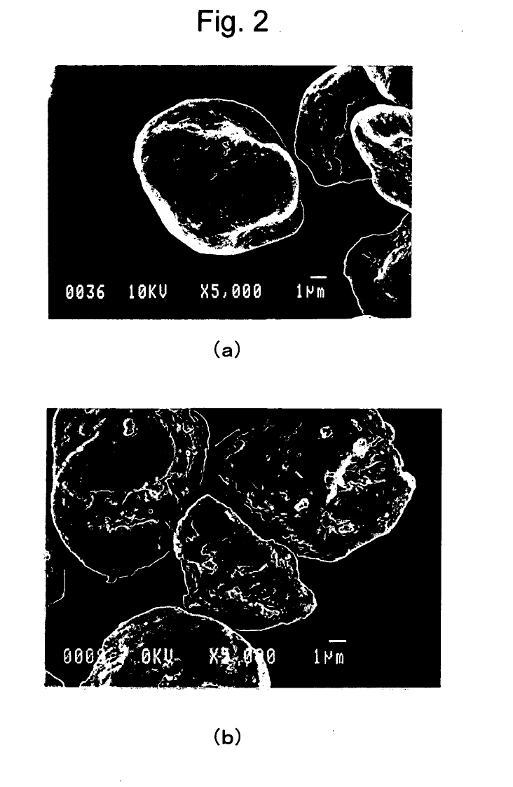

As needed in evaluation tests, the toner roundness and the toner particle size distribution were adjusted to obtain the toner particles of Samples Nos. 1 to 11 as shown in Table 1. FIG. 2A is a photograph showing Sample No. 2 as the toner particles according to the present invention, and FIG. 2B is a photograph showing Sample No. 7 as the toner particles beyond the scope of the present invention.

TABLE 1

| | | | Charge Amount | | Ratio |
|---|---|---|---|---|---|
| | Mean | | (μC/g) | | of Charge |
| Smple | Particle | Mean | | On the | Amount |
| No. | Size | Roundness | On the drum (D) | sleeve (S) | (D/S) |
| 1 | 8.5 | 0.940 | 12.2 | 4.5 | 2.7 |
| 2 | 7.5 | 0.940 | 9.8 | 7.3 | 1.3 |
| 3 | 7.8 | 0.945 | 15.2 | 5.8 | 2.6 |
| 4 | 7.8 | 0.939 | 13.5 | 8.7 | 1.6 |
| 5 | 7.8 | 0.936 | 14.3 | 7.0 | 2.0 |
| 6 | 7.8 | 0.980 | 10.0 | 6.5 | 1.5 |
| *7 | 7.8 | 0.931 | 15.0 | 7.0 | 2.1 |
| *8 | 7.8 | 0.988 | 16.0 | 4.2 | 3.8 |
| *9 | 6.8 | 0.988 | 13.3 | 5.9 | 2.3 |
| *10 | 7.8 | 0.940 | 8.2 | 8.9 | 0.9 |
| *11 | 7.8 | 0.970 | 15.7 | 4.7 | 3.3 |

Note) Sample numbers marked with * are not within the scope of the present invention.

<Measurement of Roundness>

The average value of the roundness of the toner particles was measured in the following manner. That is, with a flow particle image analyzer, the sampled toner particles having a predetermined amount (20 mg/50 cc) were analyzed to find a circumference length L₀ of a projection image where the individual toner particles were projected on a plane. A circle having the same area as the projection image was assumed to find its circumference length L. The operation of calculating the roundness in the above-mentioned equation (1) expressed by a ratio of the two L₀/L, was performed to the entire amount of the sampled toner particles, thereby obtaining the cumulative curve of the roundness. Its central accumulated value (a 50% value) was taken as an average value. It should be noted that, because the particles having a size of not more than 2 μm equivalent to the circle are most likely the external additive, the data thereof were deleted for calculation.

The used flow particle image analyzer was “FPIA-2100” manufactured by SYSMEX CORPORATION. At the time of measurement, the machine temperature of the FPIA-2100 was retained at 25° C.±1.0° C. Measurements were made ten times by preparing one sample per measurement. The ten measured values were averaged to obtain an average value. The calibration was performed automatically by using latex particles of 2.0 μm.

<Measurement of Particle Size Distribution>

The particle size distribution of the toner particles was measured by using “Multisizer 3” being a Coulter counter manufactured by Beckman Coulter, Inc.

<Measurement of Ratio of Charge Amount>

To determine the charge amount of the toner on the developer carrier (the developing sleeve) before development to the photosensitive material, 15 points of a toner thin layer on the developer carrier (after passing through the doctor blade and before development) were sucked uniformly over the developer carrier by a suction type charge meter (Q/M meter 210HS) manufactured by Trek Inc. At this time, a special close attention was paid so as not to suck excess toner from the surrounding of the nozzle of the charge meter. That is, the circumferential toner, particularly the toner on the thin layer surface had high charge, and it was therefore necessary to eliminate the influence thereof. In order not to suck the excess toner in the region larger than the diameter of the nozzle, the necessary toner layer was cut out with a rubber blade, and a rectangular partition jig fit in the sleeve was used.

The charge amount of the toner on the electrostatic charge image carrier (hereinafter referred to as a “photosensitive drum” in some cases) after development was determined as follows. That is, solid black was developed on the photosensitive drum. In the process where the toner flied to the photosensitive drum and was then transferred thereto (Provided that the test was conducted with the transfer function removed), 15 points were sucked uniformly directly over the photosensitive drum by the above-mentioned charge meter.

The average charge amount of the toner before and after the development found from the above measured values were substituted into the equation (1), and calculated.

<Evaluation Tests and Evaluation Methods>

Using the developers of Samples Nos. 1 toll shown in Table 1, the evaluation tests of image characteristics at the initial stage and after printing 300,000 duplicates, as well as under the environments of high-temperature and high-humidity, and low-temperature and low-humidity were conducted by using a printer (Model FS-3800) manufactured by KYOCERA MITA Corp., equipped with a positive charged a-Si photosensitive drum and an aluminium sleeve. At the initial stage, the image immediately after installing the toner was evaluated. The evaluation after printing 300,000 duplicates was made using the image after an ISO-4% copy was continuously printed to obtain 300,000 duplicates (10,000 duplicates per day). The evaluation under the high-temperature and high-humidity environment was performed using the initial image after leaving at an environmental test room of 35° C. and 85% RH for about 12 hours. The evaluation under the low-temperature and low-humidity environment was performed using the initial image after leaving at an environmental test room of 10° C. and 20% RH for about 12 hours. The conditions of toner ears and image quality were also examined.

The evaluation methods and the evaluation criteria of the above-mentioned characteristics were as follows.

With respect to image density, an image evaluation pattern was printed, as the initial image, by the above-mentioned printer at the initial stage under environment of normal temperature and normal humidity (20° C., and 65% RH). After 300,000 papers were continuously fed, the image evaluation pattern was printed as an after-endurance image. The solid images in the two printed images were measured by Macbeth reflection densitometer (RD914) The densities of five points in a constant solid part were measured, and its average value (ID) was calculated. In the evaluation criteria, the image density of 1.30 or more was regarded as acceptance, which was indicated by the symbol “∘”.

With respect to image density uniformity, the image characteristic was evaluated by visual observation. In the evaluation criteria, superior uniformity was indicated by the symbol “∘”, slight non-uniformity was indicated by the symbol “Δ”, and considerable non-uniformity was indicated by the symbol “x”.

With respect to fog, the image characteristic was evaluated by visually observing fog. In the evaluation criteria, no fog was indicated by the symbol “∘”, slight fog was indicated by the symbol “Δ”, and considerable fog was indicated by the symbol “x”.

With respect to toner omissions occurred in printed characters (i.e. “nakanuke” phenomenon in Japanese) during transfer, three cards were continuously fed at the initial stage and after printing 300,000 duplicates. A 10-point character was magnified 500 times and observed to examine the toner omissions of the character. In the evaluation criteria, no toner omission was indicated by the symbol “∘”, slight toner omissions were indicated by the symbol “Δ”, and considerable toner omissions were indicated by the symbol “x”.

With respect to cleaning property, the degree of cleaning was observed at the initial stage and after printing 300,000 duplicates. The photosensitive drum and the transferred image were visually observed as to whether black streaks appeared on the white area in the paper. In the evaluation criteria, the case where no defect appeared on the drum and on the image was indicated by the symbol “∘”, the case where no black streak appeared but defects appeared on the drum was indicated by the symbol “Δ”, and the case where black streaks appeared on the image was indicated by the symbol “x”.

The results of the evaluations are shown in Table 2 and Table 3.

TABLE 2

| | | | | Image Density | | | | | |
|---|---|---|---|---|---|---|---|---|---|
| | Image Density | | | Uniformity | | | Fog | | |
| | | After | | | After | | | After | |
| Sample No. | Initial | 300,000 | H/L | Initial | 300,000 | H/L | Initial | 300,000 | H/L |
| 1 | 1.42 | 1.32 | 1.36/1.38 | ∘ | ∘ | ∘ | ∘ | ∘ | ∘/∘ |
| 2 | 1.43 | 1.4 | 1.40/1.41 | ∘ | ∘ | ∘ | ∘ | ∘ | ∘/∘ |
| 3 | 1.39 | 1.33 | 1.35/1.43 | ∘ | ∘ | ∘ | ∘ | ∘ | ∘/∘ |
| 4 | 1.39 | 1.33 | 1.38/1.40 | ∘ | ∘ | ∘ | ∘ | ∘ | ∘/∘ |
| 5 | 1.4 | 1.38 | 1.34/1.39 | ∘ | ∘ | ∘ | ∘ | ∘ | ∘/∘ |
| 6 | 1.43 | 1.38 | 1.35/1.39 | ∘ | ∘ | ∘ | ∘ | ∘ | ∘/∘ |
| *7 | 1.33 | 1.13 | 1.19/1.23 | ∘ | Δ | Δ | ∘ | Δ | Δ/Δ |
| *8 | 1.28 | 1.01 | 1.20/1.30 | Δ | x | Δ/Δ | Δ | x | Δ/Δ |
| *9 | — | — | — | x | — | — | Δ | — | — |
| *10 | 1.32 | 1.12 | 1.24/1.30 | Δ | x | Δ/x | x | x | Δ/x |
| *11 | 1.19 | 0.98 | 1.08/1.20 | ∘ | x | Δ/x | x | x | Δ/Δ |

Note 1) Sample numbers marked with * are not within the scope of the present invention.
Note 2) “H/L” means the ratio of (H) the measured value under high temperature and high humidity to (L) the measured value under low temperature and low humidity.

TABLE 3

| | | Toner Omission | | | |
|---|---|---|---|---|---|
| | | under Transfer | | Cleaning | |
| | Sample No. | Initial | After 300,000 | Initial | After 300,000 |
| | 1 | ◯ | ◯ | ◯ | ◯ |
| | 2 | ◯ | ◯ | ◯ | ◯ |
| | 3 | ◯ | ◯ | ◯ | ◯ |
| | 4 | ◯ | ◯ | ◯ | ◯ |
| | 5 | ◯ | ◯ | ◯ | ◯ |
| | 6 | ◯ | ◯ | ◯ | ◯ |
| * | 7 | Δ | X | ◯ | Δ |
| * | 8 | ◯ | ◯ | X | X |
| * | 9 | ◯ | — | X | — |
| * | 10 | ◯ | X | Δ | Δ |
| * | 11 | ◯ | ◯ | X | X |

Note) Sample numbers marked with * are not within the scope of the present invention.

As shown in Table 2 and Table 3, Sample No. 7 was too low in roundness and hence had image quality deterioration and poor durability. Sample No. 8 was high in roundness and hence had superior initial image, but it was too high in the ratio of charge amount and hence had a reduction in image density and poor cleaning. Sample No. 9 had a small size of toner particles and a high roundness, so that many disadvantages occurred which could be caused by too high flowability. That is, the toner layer on the sleeve could not be formed stably, resulting in poor cleaning. Sample No. 10 was too low in the ratio of charge amount and therefore, due to too large contribution of the toner of low charge to the development, the image density was reduced and the generation of fog was promoted. This was the state of out of control in electric field. Sample No. 11 was too high in the ratio of charge amount and therefore, due to too large contribution of the toner of high large charge to the development, the number of toners to be developed was reduced and a reduction in image density took place even at the initial stage.

In contrast, Samples Nos. 1 to 6, within the scope of the present invention, toner ears could be formed stably to the toner layer on the sleeve at the initial stage and for a long period of time, without causing any fog. This achieved printing of high resolution and high image quality. The reason for this could be estimated as follows. That is, the toner roundness conformed to the system, and adjusting the charge amount of the toner by the adjustment of the particle size distribution could sharpen the distribution of the charge amount of the toner. Consequently, the toner layer could be formed stably for a long period of time. It was confirmed that the charge amounts of the toner before and after the development were balanced as the entire system, thus leading to a notable superior long-term stability.

### Example 2

The evaluation tests were conducted in the same manner as in Example 1, except that the developing sleeve was formed of stainless steel, instead of aluminium. The material of the stainless steel was SUS305.

Firstly, in the same manner as in Example 1, toner roundness and toner particle size distribution were adjusted to obtain the toner particles of Samples Nos. 12 to 22 as shown in Table 4.

TABLE 4

| | Mean | | | | Ratio of Charge |
|---|---|---|---|---|---|
| | Particle Size | Mean | Charge Amount (μC/g) | | Amount |
| Sample No. | (μm) | Roundness | On the drum (D) | On the sleeve (S) | (D/S) |
| 12 | 8.5 | 0.940 | 12.1 | 4.2 | 2.9 |
| 13 | 7.2 | 0.940 | 10.2 | 7.6 | 1.3 |
| 14 | 7.8 | 0.945 | 13.9 | 5.5 | 2.5 |
| 15 | 7.8 | 0.939 | 12.4 | 6.3 | 2.0 |
| 16 | 7.8 | 0.936 | 11.6 | 7.0 | 1.7 |
| 17 | 7.8 | 0.980 | 10.4 | 7.8 | 1.3 |
| *18 | 7.8 | 0.931 | 14.6 | 7.2 | 2.0 |
| *19 | 7.8 | 0.988 | 16.0 | 4.0 | 4.0 |
| *20 | 6.8 | 0.988 | 13.4 | 6.3 | 2.1 |
| *21 | 7.8 | 0.940 | 7.8 | 8.3 | 0.9 |
| *22 | 7.6 | 0.959 | 15.5 | 4.6 | 3.4 |

Note) Sample numbers marked with * are not within the scope of the present invention.

<Evaluation Tests and Evaluation Methods>

Using the developers of Samples Nos. 12 to 22 shown in Table 4, the evaluations were performed by the same evaluation test, evaluation methods and evaluation criteria as in Example 1, except for the use of a printer (Model KM-50350, equal magnification, A4, lateral, 50 ppm) manufactured by KYOCERA MITA Corp., equipped with a positive charged a-Si photosensitive drum and an SUS (stainless steel) sleeve, and the following evaluation of the toner layer state.

The evaluation of the toner layer state on the developing sleeve was performed by visually observing the magnetic brush state on the developing sleeve. In the evaluation criteria, the case where the magnetic brush was uniformly formed, without having non-uniformity was indicated by the symbol “∘”, the case where the magnetic brush was thick in part (slightly non-uniform) was indicated by the symbol “Δ”, and the presence of non-uniformity was indicated by the symbol “x”.

The results of the evaluations are shown in Table 5 and Table 6.

TABLE 5

| | Toner Layer | | | | | Image Density | | | | | |
|---|---|---|---|---|---|---|---|---|---|---|---|
| | State | | Image Density | | | Uniformity | | | Fog | | |
| Sample | | After | | After | | | After | | | After | |
| No. | Initial | 300,000 | Initial | 300,000 | H/L | Initial | 300,000 | H/L | Initial | 300,000 | H/L |
| 12 | ∘ | ∘ | 1.43 | 1.35 | 1.37/1.39 | ∘ | ∘ | ∘ | ∘ | ∘ | ∘/∘ |
| 13 | ∘ | ∘ | 1.43 | 1.41 | 1.41/1.43 | ∘ | ∘ | ∘ | ∘ | ∘ | ∘/∘ |
| 14 | ∘ | ∘ | 1.39 | 1.38 | 1.37/1.43 | ∘ | ∘ | ∘ | ∘ | ∘ | ∘/∘ |
| 15 | ∘ | ∘ | 1.40 | 1.38 | 1.38/1.40 | ∘ | ∘ | ∘ | ∘ | ∘ | ∘/∘ |
| 16 | ∘ | ∘ | 1.40 | 1.38 | 1.36/1.39 | ∘ | ∘ | ∘ | ∘ | ∘ | ∘/∘ |
| 17 | ∘ | ∘ | 1.43 | 1.38 | 1.33/1.39 | ∘ | ∘ | ∘ | ∘ | ∘ | ∘/∘ |
| *18 | ∘ | Δ | 1.33 | 1.10 | 1.19/1.23 | ∘ | Δ | Δ | ∘ | Δ | Δ/Δ |
| *19 | Δ | x | 1.28 | 1.05 | 1.20/1.30 | Δ | x | Δ/Δ | Δ | x | Δ/Δ |
| *20 | x | — | — | — | — | x | — | — | Δ | — | — |
| *21 | ∘ | Δ | 1.29 | 1.10 | 1.24/1.25 | Δ | x | Δ/x | x | x | Δ/x |
| *22 | ∘ | Δ | 1.19 | 0.91 | 1.12/1.15 | ∘ | x | Δ/x | x | x | Δ/Δ |

Note 1) Sample numbers marked with * are not within the scope of the present invention
Note 2) “H/L” means the ratio of (H) the measured value under high temperature and high humidity to (L) the measured value under low temperature and low humidity.

TABLE 6

| | | Toner Omission | | | |
|---|---|---|---|---|---|
| | | under Transfer | | Cleaning | |
| | Sample No. | Initial | After 300,000 | Initial | After 300,000 |
| | 12 | ◯ | ◯ | ◯ | ◯ |
| | 13 | ◯ | ◯ | ◯ | ◯ |
| | 14 | ◯ | ◯ | ◯ | ◯ |
| | 15 | ◯ | ◯ | ◯ | ◯ |
| | 16 | ◯ | ◯ | ◯ | ◯ |
| | 17 | ◯ | ◯ | ◯ | ◯ |
| * | 18 | Δ | X | ◯ | Δ |
| * | 19 | ◯ | ◯ | X | X |
| * | 20 | ◯ | — | X | — |
| * | 21 | ◯ | X | Δ | Δ |
| * | 22 | ◯ | ◯ | X | X |

Note) Sample numbers marked with * are not within the scope of the present invention.

As shown in Table 5 and Table 6, Sample No. 18 was too low in roundness and hence had image quality deterioration and poor durability. Sample No. 19 was high in roundness and hence had superior initial image, but it was too high in the ratio of charge amount and hence had a reduction in image density and poor cleaning. Sample No. 20 had a small size of toner particles and a high roundness, so that many disadvantages occurred which could be caused by too high flowability. That is, the toner layer on the sleeve could not be formed stably, resulting in poor cleaning. Sample No. 21 was too low in the ratio of charge amount and therefore, due to too large contribution of the toner of low charge to the development, the image density was reduced and the generation of fog was promoted. This was the state of out of control in electric field. Sample No. 22 was too high in the ratio of charge amount and therefore, due to too large contribution of the toner of high charge to the development, the number of toners to be developed was reduced and a reduction in image density took place even at the initial stage.

In contrast, Samples Nos. 12 to 17, within the scope of the present invention, toner ears could be formed stably to the toner layer on the sleeve at the initial stage and for a long period of time, without causing any fog. This achieved printing of high resolution and high image quality. The reason for this could be estimated as follows. That is, the toner roundness conformed to the system, and adjusting the charge amount of the toner by the adjustment of the particle size distribution could sharpen the distribution of the charge amount of the toner. Consequently, the toner layer could be formed stably for a long period of time. Even when used the developing sleeve of the stainless steel, it was confirmed that the charge amounts of the toner before and after the development were balanced as the entire system, thus leading to a notable superior long-term stability.

### Example 3

Using the Sample No. 12, the evaluations of the toner thin layer state, initial image density, and leak black spots were conducted by changing the surface roughness Rz of the above developing sleeve formed of the SUS used in Example 2, to the values shown in Table 7, respectively. The toner thin layer state and the initial image density were evaluated in the same manner as in Example 2. The evaluation of leak black spots was as follows. That is, under the environment of normal temperature and normal humidity (20° C. and 55% RH), the printer used in Example 2, KM-50350, was used to output a white image at the initial stage. Then, the evaluation was conducted based on the number of black spots which were present on the white image and had a diameter of 0.1 mm or more. In the evaluation criteria, the case where the number of the black spots was zero was indicated by the symbol “∘”, the case where the number of the black spots was 1 to 4 was indicated by the symbol “Δ”, and the case where the number of the black spots was five or more was indicated by the symbol “x”.

The results of the evaluations are shown in Table 7.

TABLE 7

| | | Developing | | | |
|---|---|---|---|---|---|
| | | Sleeve | Toner Thin | Initial Image | Leak Black |
| | | Rz(μm) | Layer State | Density | Spots |
| | 23 | 7.2 | ◯ | 1.43 | ◯ |
| | 24 | 5.6 | ◯ | 1.44 | ◯ |
| | 25 | 8.2 | ◯ | 1.40 | ◯ |
| * | 26 | 5.1 | X | — | — |
| * | 27 | 8.8 | Δ | 1.32 | X |

Note) Sample numbers marked with * are not within the scope of the present invention.

As shown in Table 7, Sample No. 26 had turbulence in the toner thin layer at the time of install especially under the environment of low temperature and low humidity. Sample No. 27 had the leak black spots. The reason for this could be considered as follows. That is, due to a large surface roughness, the thickness of the toner layer was too large to obtain a stable layer. As the result, the gap with the photosensitive material was reduced and hence bias leaked.

In contrast, Samples Nos. 23 to 25, within the scope of the present invention, had no leak black spots and had superior results with respect to the toner thin layer state and the initial image density.

What is claimed is:

1. A toner for developing an electrostatic charge image containing at least a binder resin, a release agent, and a charge control agent, wherein a ratio of an average charge amount of toner developed on an electrostatic charge image carrier to an average charge amount of a toner thin layer on a developer carrier before development satisfies the following equation (1), and wherein the toner has a mean roundness of 0.935 to 0.985,
1.0≦A/B≦3.0 (1)
where A is an average charge amount of toner after development;
and B is an average charge amount of toner before development.

2. The toner according to claim 1, containing a magnetic body.

3. The toner according to claim 1, having a mean particle of 5.0 to 10.0 μm.

4. The toner according to claim 1, the toner being manufactured by melt-kneading a mixture of at least the binder resin, the release agent, and the charge control agent, followed by the steps of cooling and grinding.

5. The toner according to claim 4, wherein the step of grinding includes grinding a melt kneaded matter by a flow grinder, followed by grinding by a mechanical grinder.

6. The toner according to claim 4, wherein an external additive is added to a toner surface.

7. An image forming method using a contact-transfer system in a transfer step and a blade-cleaning system in a cleaning step, wherein the toner according to claim 1 is used.

8. The image forming method according to claim 7, comprising:
a contact-charge step of applying a charge voltage by bringing a charge roller into contact with a surface of an electrostatic charge image carrier;
an exposure step of forming an electrostatic latent image by exposing the surface of the electrostatic charge image carrier;
a development step of forming a toner image by allowing a charging toner of a predetermined polarity to adhere from a developer carrier to the electrostatic latent image on the electrostatic charge image carrier;
a contact-transfer step of transferring the toner image on the electrostatic charge image carrier to a transfer material conveyed, by applying a transfer voltage to the transfer material; and
a cleaning step of recovering, by a cleaning blade, a non-transferred toner remained on the electrostatic charge image carrier.

9. The image forming method according to claim 7, wherein the developer carrier is formed of stainless steel.

10. The image forming method according to claim 7, wherein the developer carrier has a surface roughness Rz of 5.5 μm to 8.5 μm.
